(19) United States
(12) Patent Application Publication
(10) Pub. No.: US 2005/0076569 A1
(43) Pub. Date: Apr. 14, 2005

(54) Boss and shutter assembly

(75) Inventors: Robert Phillip Griffiths, Mascot (AU); Justin Aaron Griffiths, Erskinville (AU)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Robert Phillip Griffiths

(21) Appl. No.: 10/601,461

(22) Filed: Jun. 23, 2003

Related U.S. Application Data
(63) Continuation of application No. PCT/AU01/01650, filed on Dec. 21, 2001.

(30) Foreign Application Priority Data
Dec. 22, 2000 (AU) PR 2283
Dec. 22, 2000 (AU) PR 2282
Aug. 24, 2001 (AU) PR 7241

(51) Int. Cl. E06B 7/096

(52) U.S. Cl. 49/82.1

(57) ABSTRACT

A boss (30) for use in a shutter having blades, the boss including an axial pin about which the boss is adapted to rotate, a complementary surface adapted to engage a translating member such as a toothed rack, a bearing surface adapted to rest in or on a support in the shutter assembly and blade engaging means (48). A shutter assembly and blade configuration are also disclosed.

### TECHNICAL FIELD

The present invention relates to a boss for use in a shutter assembly and to the shutter assembly itself.

### BACKGROUND ART

Shutter assemblies have been described in which a plurality of louvre blades are rotationally set in a frame to rotate about parallel axes in a single plane. The louvre blades are adapted to pivot in a synchronised manner by connection to a common cord or slat extending transversely relative to the louvre slats and, in an arrangement set in a vertical plane, the cord or slat is adapted to move up or down in a vertical direction to pivot the louvre slats in unison. The frames in which the previously described shutter assembly is set is generally of a light construction requiring the inclusion of a mid rail to improve structural stability due to the small profile frame. The previously described louvre slats are generally pivoted about a small dowel or pin located in a single piece small section side rail.

Typically, the shutter assembly of the present invention includes a plurality of shutter blades, each blade being axially rotatable in unison with each other blade in the assembly. The shutter assembly of the present invention may be mountable in a winged frame such as may be used for a door or a window or may be mounted in a fixed frame such as may be used in a window.

It is an object of the present invention to provide an improvement over prior art bosses and/or shutter assemblies or useful alternatives thereto.

### DISCLOSURE OF THE INVENTION

Compact Boss

Accordingly, the invention provides in one aspect a boss for use in a shutter assembly having a plurality of shutter blades, said boss including:
a) a short axial member whereby the boss is adapted to rotate about the axis of the axial member;
b) a complementary surface adapted to engage a translating member capable of translating the linear motion of the translating member into rotational movement of the boss;
c) a bearing surface adapted to rest in or on a support in the shutter assembly; and
d) blade engagement means to impart rotational motion to the blade corresponding to the rotational motion of the boss.

The blade engagement means preferably engages the boss with the blade at two or more locations off-centre relative to the axis of rotation of the axial pin.

Cassette for Shutter Assembly

The invention may also provide a cassette for a shutter assembly, said cassette including:
a pair of opposed, parallel, spaced elongate members, at least one said elongate member having a plurality of regularly spaced supports;
a translating member adapted to travel reciprocally along or within said at least one of said elongate members;
a plurality of compact bosses adapted to co-act in unison with said translating member to translate the reciprocal motion of said translating member into rotational motion, each said boss located in or on one of said supports; and
a plurality of shutter blades, each said blade engaged with one of said bosses,
   wherein the pair of elongate members are adapted to remain substantially co-planar relative to each other during installation of said cassette without the need for top or bottom reinforcing rail members parallel to the blades.

In a particularly preferred embodiment the cassette incorporates a modular kit installable as an operable shutter assembly with a hidden mechanism. The cassette is preferably in a modular form ready to be installed into a pre-existing wall opening. The cassette may be available in a range of sizes generally corresponding to standard wall opening dimensions which may vary from one jurisdiction to another. Each cassette may be engageable to like cassettes whereby to cover a wall opening larger than an individual cassette. The cassettes may be engageable side by side whereby the opposed outer wall of adjacent elongate members may be engaged. The elongate members of adjacent cassettes may be engaged one on top of the other.

The outer wall of the elongate member may include any one of a variety of elongate member engagement means whereby to engage an adjacent cassette. For example, an outer wall of the elongate member may include male members adapted to engagedly cooperate with female members on an elongate member of an adjacent cassette. The male members may include headed pins. The male members may include snap lock locaters. The female members may include any one of apertures, grooves, tracks, slots or the like. The elongate member engagement means may include tenon and mortise or tongue and groove combinations and the like.

The invention may also provide a method of installing one or more cassettes having a pair of opposed parallel elongate members spaced from each other by a plurality of shutter blades rotatably mounted therebetween. According to this aspect of the invention, the one or more cassettes may be installed in a wall opening, the method including the following steps:
(a) calculating the number of the cassettes required to cover the wall opening;
(b) rabbeting an existing stile in the wall opening sufficient to form a recess adapted to retain the elongate member within the stile such that the elongate member lies flush with the outer surface of the stile; and
(c) locating the elongate member within the stile,
   wherein the pair of elongate members are adapted to remain substantially co-planar during installation of each cassette without the need for top or bottom reinforcing rail members parallel to the blades.

In an optional method to that described above, steps (b) and (c) above may be replaced by the following step: (d) positively fixing at least one of the elongate members to an existing stile in the wall opening whereby the elongate member sits proud of the outer surface of the stile.

Where the elongate member sits proud of the stile, the cassette may be positioned to sit either forward or behind a centre line of the wall opening. The cassette may be incorporated into or be installed proud of an existing stile of an existing fixed glass or operable opening. The cassette may be mounted in a variety of ways depending on design outcomes, such as orienting the blades so that they will project proud from the front or rear of the frame. Locating the elongate member merely on the outer surface of the vertical frame member of the wall opening may be a useful method whereby to minimise the amount of work required by, for example, an amateur builder unwilling or unable to form a suitable recess in a pre-existing vertical frame member.

It will be appreciated, however, that installing the elongate member in the vertical frame member has the advantage of maximising the ventilation and viewing area afforded by the original wall opening, unlike prior art shutter assemblies where a significant proportion of the available wall opening area is taken up by the vertical housings (accommodating the blade rotation mechanism) and the top and bottom rails extending horizontally therebetween, which rails provide the structural rigidity required for the framed shutter assembly in the prior art.

The elongate member may be made from a variety of suitable materials, including aluminium and polymeric materials. For example, the elongate member may be formed from cast aluminium. Alternatively, the elongate member may be formed from injection moulded plastic. The material used, to a large extent, will be determined by such factors as: required level of security and attendant strength requirements, live load calculations, wind load calculations, anticipated exposure to weather and aesthetic considerations such as colour and surface finish.

The elongate member is preferably of constant cross-section along its entire length. The elongate member may be a solid structure. Preferably, the elongate member defines a track, recess, groove, slot or channel along or within which the translating member travels. Still more preferably, the elongate member is in the form of a housing, the housing may define an internal cavity. The internal cavity may have dimensions which permit linear travel of the translating member in a longitudinal direction within the housing but permits the translation member substantially no lateral play. The housing may be configured to enable the translating member to interact with each boss.

Preferably, the interaction between the translating member and the boss is by direct physical contact. Preferably, the linear movement of the translating member engages with the boss to impart the required rotational motion to the boss. Typically, this may be achieved by a rack and pinion-type arrangement. The translating member may interact with the boss by frictional engagement. Frictional engagement may be achieved by, for example, a belt with a high frictional surface such as may be achieved by a belt made of rubber or other flexible, resilient and/or elastic materials. The translating member may have a roughened or corrugated surface adapted to co-act with a complementary surface on the boss. The complementary surface on the boss may be cylindrical. The interaction may be effected by a combination of protrusions and recesses located on either or both the translating member and the boss. Preferably, the translating member is a rigid rod or bar, such as a rack, with protruding teeth adapted to mesh with complementary geared teeth on the complementary surface of the boss. The translating member may perform the dual function of engaging with and rotating the boss as well as assisting to secure the boss in the housing. This may be achieved by the cog of the boss and the rack meshing and the boss being held in position by an inside bearer. It will be appreciated that the translating member may be included in or on only one of the elongated members and that the opposed elongate member may comprise merely a rod, for example, adapted to support the other end of the blade for rotation. For example, the opposed elongate member may include a single pin located in an aperture whereby the blade is free to rotate about the pin.

The support may include an aperture located in the inner wall of the housing facing the shutter blade. The boss may be stably retained for rotation about a single axis by the headed axial pin extending outwardly from the outer end of the boss. The headed axial pin may be located in a second aperture adapted to permit substantially no play lateral to the axis of rotation of the boss. Intermediate the headed pin and the gear of the boss may be a bush. The bush may be substantially cylindrical. The bush may be adapted to seal the second aperture to prevent ingress of dirt and grime into the internal cavities of the housing.

The blade engagement means may include any one of a number of suitable means for engaging the end of the shutter blade with the boss whereby to impart rotational motion to the blade corresponding to the rotational motion of the boss. The blade engagement means may include a protrusion extending from the boss. The protrusion may, alternatively, be located on the end of the shutter blade. The blade engagement means may include two or more protrusions. Each protrusion may be keyed to co-act with a correspondingly configured recess. For example, one or more of the protrusions may be polygonal in cross-section or may be keyed with lateral projections which co-act with corresponding features in the complementary recess. Preferably, the protrusions include snap lock locaters non-releasably receivable in corresponding apertures. The blade engagement means may include two protrusions locaters extending from the boss and non-releasably insertable in corresponding apertures in the end of the blade. In a preferred embodiment, the protrusions extend from the internal face of the bearing or, in the absence of the bearing, the gear. The bearing is preferably of suitable dimensions whereby to provide a seal at the support to prevent the ingress of dirt and grime into the internal cavities of the housing. The blade engagement means may include an end cap formed integrally with, or fixedly pre-attached to, the boss. The end cap may be adapted to form a shallow sleeve to cover, strengthen and engage with the end of the blade. The end cap may also act as a seal for timber and extruded blades. The end cap may be omitted where timber blades are used for aesthetic reasons and where weather or strength considerations, for example, are not an issue.

The boss may be a compact structure mounted for rotation in the housing. The boss may be seated for rotation in one of the supports of the housing. The mounting of the boss may be a tight fit whereby there is substantially no play relative to the axis of rotation of the boss. This may be achieved by configuring the support to closely complement a bearing of the boss. The bearing may be substantially cylindrical whereby to rotate within a corresponding cylindrical bore of the support. The bearing may be made of a low-friction and/or self-lubricating material. The boss preferably includes an outwardly extending headed pin in the form of a snap lock locater located along the axis of rotation of the boss, a bush co-axial to the headed pin and cylindrically shaped, a toothed gear adapted to engage the translating member and capable of translating the linear motion of the translating member into rotational movement of the boss, a cylindrically shaped bearing adapted to rest in a circular aperture, and extending internally from the inner face of the bearing, a pair of protrusions in the form of snap lock locaters adapted to non-releasably engage with corresponding apertures in the end of the shutter blade. It is considered that the blade engagement means in the form of a pair of protrusions provides a mechanical advantage over that of a single protrusion because the points of engagement are offset from the axis of rotation.

The shutter blade may include a number of configurations familiar to those skilled in the art, provided that at least one of its ends is suitably adapted to engage the boss. The blade may include one or more end attachments to facilitate the engagement between the blade and the boss. The blade may include one or more end caps. The end cap may be in the form of a short sleeve extending part way over the surface of the blade from one end. The end cap may include apertures adapted to include boss engagement means complementary to the blade engagement means. The end cap may be made of a self-lubricating material whereby to decrease friction between the end cap and the elongate member as the blade is rotated. The end cap may be formed integrally with or fixedly pre-attached to the boss as previously discussed. The end cap may be adapted to complement a variety of blade profiles. For example, the end cap may be adapted to conform to elliptical, ovaloid, rectangular and other suitable blade profiles. The end cap may include a moveable wall to allow insertion or removal of the blade in situ. For example, the moveable wall may be hinged. The moveable wall may comprise one section of a sleeve portion of the end cap. The moveable wall may comprise about one quarter of the sleeve portion. The moveable wall may be located in the top section of the sleeve portion. The moveable wall may include attachment means to secure the moveable wall in place once the blade is inserted.

Modular Unit for Shutter Assembly

In another aspect the invention may also provide a modular unit for a shutter assembly, said modular unit adapted to mount a shutter blade and including:
an elongate member unit stackable and engageable to like elongate member units to form an assembled elongate member; and
a support for a compact boss adapted to be engaged to the shutter blade, whereby rotation of the compact boss causes rotation of the shutter blade.
wherein the elongate member is adapted to facilitate the reciprocal travel of a translating member along or within the assembled elongate member and the support is adapted to support the compact boss for co-action with the translating member to translate the reciprocal motion of the translating member into rotational motion in the compact boss whereby to pivot the shutter blade.

The elongate member unit may be formed from one or more components. The elongate member unit may include a unitary integrally moulded or cast component. The elongate member unit may include two or more separately formed components adapted to be joined together. The elongate member unit may be formed from a pair of separately formed components adapted to be engaged to one another to form the elongate member unit.

The engagement of the modular unit to adjacent like member units may include a variety of modular unit engagement means. For example, the modular unit engagement means may include male members adapted to engagedly co-operate with female members on an adjacent member unit. The male members may include headed pins. The modular unit engagement means may include snap lock locaters. The modular unit engagement means may include any one of apertures, grooves, tracks, slots or the like.

Preferably, the modular unit includes a pair of halves separately formed and having component engagement means. The component engagement means may include any suitable means for securing two or more such components together. The component engagement means may include similar means as that used for the modular unit engagement means. The component engagement means may be in the form of interference fit pins adapted to locate in corresponding apertures. For example, a first half of the elongate member unit may include at least one interference fit pin adapted to engage with at least one corresponding aperture in the other half. The elongate member unit may define a cavity in which the translation member is adapted to travel. The elongate member may be assembled from modular units to form a housing defining an internal cavity. The assembled elongate member may be adapted to house a pair of opposed translation members adapted to co-act in unison with the compact bosses. The translating member may be in the form of a toothed rack adapted to co-act with a compact boss in the form of a toothed wheel or pinion.

The support may be in the form of a circular aperture in a wall of the elongate member unit. An opposed internal wall of the elongate member unit may include a recess or aperture to locate a spigot extending coaxially from the compact boss to stabilise the structure and facilitate the rotation of the compact boss about a constant axis. Alternatively the internal wall may include a protrusion adapted to coaxially engage the compact boss mounted thereto for rotation.

The translating member may be adapted to co-act with a turning means. The turning means may be adapted to be controlled by an operator. The turning means may be manual. The turning means may be motorised. The turning means may be responsive to environmental conditions and diurnal cycles. For example, the shutter assembly may be automatically opened during daylight hours and closed during the night. The shutter assembly may be adapted to open in moderate temperature conditions and to close in excessively cold or hot conditions. The shutter assembly may include environmental sensors suitable for the purpose. The turning means may be adapted to co-act directly with the translating member. Preferably, the turning means is adapted to co-act with one of the compact bosses in an assembled elongate member. The turning means may include any standard mechanism adapted to translate the rotational motion of a rotatable handle about an axis normal to the plane of the shutter assembly into rotational motion about an axis parallel to the longitudinal axis of the shutter blade. For example, the turning means may include a worm gear arrangement. Alternatively, the modular unit may include a slot adjacent the translating member along which a manually controlled handle may travel to operate the translating member by acting directly on the translating member.

The shutter blades may be heated or cooled to facilitate the moderation of the temperature of the environment. For example, the shutter blades may include one or more cavities or conduits through which a fluid may flow. The fluid may be a liquid such as water, coolant or a combination of both which may flow to either heat or cool the shutter blades and, by convection or conduction, the ambient temperature surrounding the shutter blades. The shutter blades may include heating elements. For example, the shutter blades may include a thin film comprising heating elements on the skin of the shutter blade. The shutter blade may be insulated for sound and/or heat insulation.

The invention may also provide a shutter arrangement including:
a frame and a plurality of shutter blades pivotably mounted in the frame and arranged in parallel relationship with their respective ends aligned;
a pivoting mechanism adapted to pivot the plurality of blades in unison, said pivoting mechanism including a pair of parallel translating members or rods capable of opposing reciprocal movement within the frame, said pair of rods having a plurality of bosses or crank key members, one for each blade, spaced along the lengths of the pair of rods and attached whereby to allow pivotal movement of the crank keys upon the opposing reciprocal movement of the pair of rods, each of said crank keys in turn fixed to one end of each corresponding blade,
   wherein the opposing reciprocal movement of the pair of rods imparts uniform pivotal movement to each of the crank keys and, correspondingly, to each of the shutter blades such that the shutter blades move in unison with one another.
   Contoured Blade

In another aspect the invention may also provide a shutter blade adapted to be pivotably mounted in a shutter frame, said blade including an elongate body having a constant cross section along its length, said body including:
a main portion extending along a first edge of the body substantially the full length of the body, said main portion having a top external surface substantially convex in profile and an underside surface and
a minor portion integrally formed with the main portion and extending along the other edge of the body substantially the full length of the body, said minor portion having a top external surface substantially concave in profile,
   whereby the portion of the underside surface of the main portion to the first edge has a profile adapted to rest in snug relationship to a like shutter blade in the depression defined by the concave external surface of the like shutter blade.

The blade may be made from a number of materials including those materials currently used for blades in the shutter industry. For example, the blades may be made of timber, such as is the case with traditional plantation shutters, metal, such as aluminium, injection moulded plastic, glass or a combination of two or more of these materials. The blade preferably has an adapted aerofoil shape comprising an upper surface having contours with opposing radii. The top external surface of the main portion may include a curve in profile with a changing radius. The radius of the profile of the top external surface of the main portion may increase towards the longitudinal edge of the main portion and correspondingly decrease towards the minor portion. The main longitudinal edge may be slightly downwardly depending. The longitudinal edge of the minor portion may be upwardly extending. The longitudinal edge of the main portion may be adapted to nestle in the depression in adjacent like blades formed between the minor longitudinal edge and the joining region between the minor portion and the major portion.

The underside surface of the main portion may follow substantially the same contour as the top external surface of the main portion, the profile of the main portion slightly tapering towards the main longitudinal edge. Intermediate the width of the body corresponding to the underside surface at the junction between the main and minor portions there may be provided a thickened area adapted for mounting the blade at either end.

The shutter frame may comprise vertical posts or stiles which house the mounting means for the blades. The stiles may be parallel relative to one another and spaced by top and bottom horizontal frame members or rails approximately the same length as the shutter blades. The frame may be assembled in any one of a number of ways common in the art, including by means of tongues and mortises. The frame may be fixed in a wall or wing, or be hingedly mounted whereby to constitute a wing.

In a preferred embodiment, interposed between the pair of rods and one end of the shutter blade may be an infill. The infill preferably extends substantially the length of the stile. The infill may include spaced apertures for retaining the crank keys to be pivotably mounted therein. The opposite end of each blade is mounted for rotation. The crank keys are mounted to each of the rods by, for example, a peg and aperture combination, pop rivets or any other suitable arrangement allowing rotation of the crank key about each attachment to each rod.

The crank key may comprise any one of a number of designs and in its simplest form merely connects the pair of rods to the blade. The crank key is adapted to translate the linear reciprocal movement of the pair of rods into rotational movement of the blade relative to the pair of rods. Accordingly, the crank key may be inter alia square, block, round, disc-shaped or cruciform-shaped. Preferably the crank key includes a doughnut shaped disc. The surface of the disc facing the stile preferably includes a pair of pegs or lugs standing proud therefrom to enable their insertion in appropriately located apertures in each of the rods. The surface of the disc facing the blade may include one or two pegs for insertion into corresponding apertures in the thick portion of the blade. This pivoting mechanism including the infill, crank key and pair of rods may be located adjacent the frame. However, preferably the pivoting mechanism is entirely housed within the stile. The stile may be rabbeted whereby to house the pivoting mechanism.

The pivoting mechanism may be connected together by attachment of the individual components to each other. However, it is preferable to have an elongate member which connects all of the components together. Accordingly, a cylindrical rod or fastener may extend from the stile, between the pair of rods, through the crank key and the infill into a locating aperture in the shutter blade whereby to secure the entire pivoting mechanism in place.

In a preferred form of the present invention, the plurality of crank keys are included so that the respective pairs of pegs on opposing faces of the crank key disc can be offset relative to one another. By offsetting the pairs of pegs a restricted pivotal motion of the shutter blades about approximately 90° may be achieved so that the blades may pivot from a substantially horizontal open position in which the flow of air through the shutter arrangement is substantially unobstructed through to a substantially vertical position in which each adjacent upper blade rests its main longitudinal edge in the recess of the minor portion of each lower adjacent blade.

In an alternative embodiment of the invention, the blade may be connected directly to the pair of rods. Upon the opposing reciprocal movement of the pair of rods, the blade may pivot in the frame. The pair of rods may be located in one or more tracks in the stile and be secured at suitably spaced intervals directly to the plurality of shutter blades, such that the crank key and infill are dispensed with. As a person skilled in the art will appreciate, the locating pegs may be located on one of the pair of rods and the shutter blade and the corresponding apertures located on the other of the pair of rods and the shutter blade.

In a particular embodiment of the invention there is provided a plantation shutter made of timber. However, it should be noted that any appropriate material could equally be used. The plantation shutter is noticeably different to prior art shutters available. In the present invention, once installed there is no control bar/arm visible because this mechanism is hidden in the vertical frame member or stile. Moreover, the louvre blade is uniquely shaped to provide advantages in terms of light and heat transfer and insulation properties as well as weather protection.

One aspect of the invention concerns the difficulties encountered in hiding the louvre rotation mechanism in the stile. It has previously been difficult to retain the louvre rotation mechanism out of view in the stile. To overcome this difficulty, firstly the stile has been rabbeted to form a cavity to retain the louvre rotation mechanism. The louvre rotation mechanism includes control arms or rods described as “flat bars”. Each flat bar is rectangular in cross section and extends substantially the length of the stile, with central apertures spaced along its length. Secondly, the louvre rotation mechanism is provided with a plurality of discs each having a pair of faces. Extending from each face of each disc is a pair of protruding pegs or lugs. Each member of each pair of pegs on each disc are not directly aligned or coaxial to a corresponding member peg on the opposite face, but is offset to a particular angle. Each peg on the face facing the louvres is adapted to be received in a complementarily sized hole in one of the flat bars. The louvre rotation mechanism may further include for each disc a screw type fastener which fastens the disc to the rabbeted stile. The fastener may pass through the centre of the disc and each of the pegs may be received in a corresponding hole of one of the flat bars. Each of the flat bars may be located between the discs and the stile. The arrangement may further include an infill made of the same material as the stile. The infill fits into the stile and is configured to allow each of the discs to reside in the infill in complementarily sized holes spaced along the length of the infill at about the same intervals as the apertures in the flat bars. The discs are adapted to rotate about the fastener within the holes in the infill. The infill is located in the stile and covers the louvre rotation mechanism. The rabbeted configuration of the stile allows the flat bars adequate movement between the louvre rotation mechanism, the stile and the infill.

The infill may be secured when the horizontal frame members or rails are secured in corresponding mortises at the ends of the stile. The fasteners secure the louvre rotation mechanism to the stile thus allowing the shutter frame to be assembled as a complete unit. Paint finish may be applied and dried before the assembly of the louvre blades. This mode of paint application is desirable in that the frame can be finished in a colour the same or different to the colour finish of the louvre blades. Thus a two toned finish may be achieved.

The assembly of a complete frame without the louvre blades is highly desirable. Currently available products on the market which are known to the Applicant are painted complete with blades. The result is an undesirable finish as the paint will not cover hard to reach areas. In other currently available examples, the paint coats the louvre rotation mechanism (normally made of a metal composite). This is most likely not compatible with the timber substrate and is likely to peel or not adhere to the metal composite resulting in an inferior paint finish. Moreover, there is the difficulty associated with popular so called d.i.y. (do it yourself) applications in which timber shutters are manufactured and sold raw (no paint finish, except a primer for certain applications). This makes a difficult job for someone without expensive paint equipment to achieve the desired finish. The difficulties confronting them involve the control rods interfering with the application of the paint, the end of the blades between the stiles being difficult to reach and finish, particularly when the second coat of paint is applied after sanding which in turn also presents difficulties.

The concept for the aerofoil design of the louvre blade occurred to the inventor whilst observing the flow of moist air which passed an aircraft wing forming a trail behind the plane. The adapted aerofoil shape may provide a natural weather seal considered most desirable by the shutter industry. In a preferred embodiment of the invention, the louvre blades include a cross section with an opposing radius to complement the full radius of an adjacent blade when the blades are oriented in a downward position relative to their centre point corresponding to the axis of the associated disc.

When so downwardly oriented it is possible that the arrangement would allow minimal drafts from outside or heat loss from inside. The louvre blades therefore optionally include a magnetic strip which runs the length of the blade and is located on the top outside edge and the bottom opposing outside edge of each louvre blade which is adapted to cooperate with corresponding magnetic strips on each adjacent louvre blade. The magnetic strips are self aligning and self adhesive and are available commercially. The magnetic strips are located whereby to attract each other when the blade is in the closed (downward) position and cause the blades to fall into alignment when the magnetic strips are in close proximity. The magnetic strips enable the blades to cooperate in a closer fitting arrangement to minimise drafts or heat loss. With regard to security, the presence of the magnetic strips increase the difficulty intruders may experience in attempting to pry open the blades with fingertips from the outside.

The arrangement correspondingly also improves privacy with respect to views external to the structure housing the shutter. The invention may also provide a closed cell foam strip of similar dimensions and adjacent to each magnetic strip. When the adjacent blades move into close proximity relative to each, the magnetic force is sufficient to compress the foam to ameliorate the problems of heat loss and drafts when in the arrangement is in the closed position.

The louvre blades may also incorporate renewable solar energy technology. the curved surface of the louvre blade may be adapted to receive solar cells or sophisticated multi-layer amorphous silicon thin-film solar cells (refer to internet website www.ovonics.com/unitedsolar/energentek.html). The solar panels so described are flexible panels capable of conforming to a curved surface such as the preferred louvre blade shape of the present invention. The flexible solar panels can be applied to the curved blades to provide solar energy storage capacity. This stored energy may be used in a number of applications, such as internal lighting, etc. The curved surface of the preferred louvre blade, when viewed from the outside of the shutter in its open state (blades are horizontal), provides two curved surfaces. Both of these curved surfaces are exposed to the outside environment. The solar cells are able to receive the solar rays from the side and do not require the solar rays to shine directly thereon. By allowing adequate reception and storage of solar energy the present arrangement has an advantage over flat form louvre blades of the prior art. A succession of blades one above the other having flat solar panels would require near direct path for the solar rays whereby to achieve satisfactory storage of solar energy. In such a case the louvre blades would generally need to be close to perpendicular to the direction of the solar rays to achieve the optimum result. This would negative the purpose of the shutter which is to provide a view of the outside as the optimum position of the blades for solar energy collection would be the worst position for the purposes of providing a view.

In another aspect, a preferred form of the shutter arrangement may include the following: (1) an innovative opposed radius louvre blade design; (2) an excellent weather seal for louvre blades situated in a wing panel; (3) improved solar energy collection arrangement for shutters; (4) an arrangement which is solar efficient in almost any blade position; (5) hidden louvre rotation mechanism which is also inaccessible in normal operation; (6) arrangement which is easier to assemble; (7) enables one to apply a superior paint finish; (8) the use of a very small rotating radius for the louvre rotation mechanism allows the louvre rotation mechanism to fit inside very narrow stiles whilst still achieving an assembly with tight tolerances; (9) a stile which is adapted to contain the louvre rotation mechanism such that it fits inside and can be secured whilst also allowing the flat bars adequate movement within the stile to operate the blades in unison.

### BRIEF DESCRIPTION OF THE DRAWINGS

The invention may be better understood from the following non-limiting description of a number of preferred embodiments, in which:

Cassette for Shutter Assembly

FIG. 1 is an exploded view of a shutter assembly according to a first embodiment;

FIG. 2 is an exploded view of a side component of the first embodiment;

FIGS. 3, 4, 5 and 6 are perspective views of components of the boss according to the first embodiment;

FIG. 7 is a top plan view of a housing according to the first embodiment;

FIG. 8 is an exploded perspective view of the means by which a boss may be engaged to an end cap of a shutter blade according to the first embodiment;

FIG. 9 is a perspective view from a different angle of the engagement means shown in FIG. 8;

FIG. 10 is an exploded view of a shutter assembly according to a second embodiment of the invention.

Modular Unit for Shutter Assembly

FIG. 11 is a partially exploded perspective view of a prior art shutter arrangement;

FIG. 12 is a partially exploded perspective view of a shutter arrangement according to a third embodiment;

FIG. 13a is a perspective view of a two piece modular unit prior to assembly and showing a pair of translating members according to a fourth embodiment;

FIG. 13b is a perspective view of the modular unit shown in FIG. 13a from a different perspective;

FIG. 14a is a front elevation of a first component of the modular unit shown in FIG. 13a;

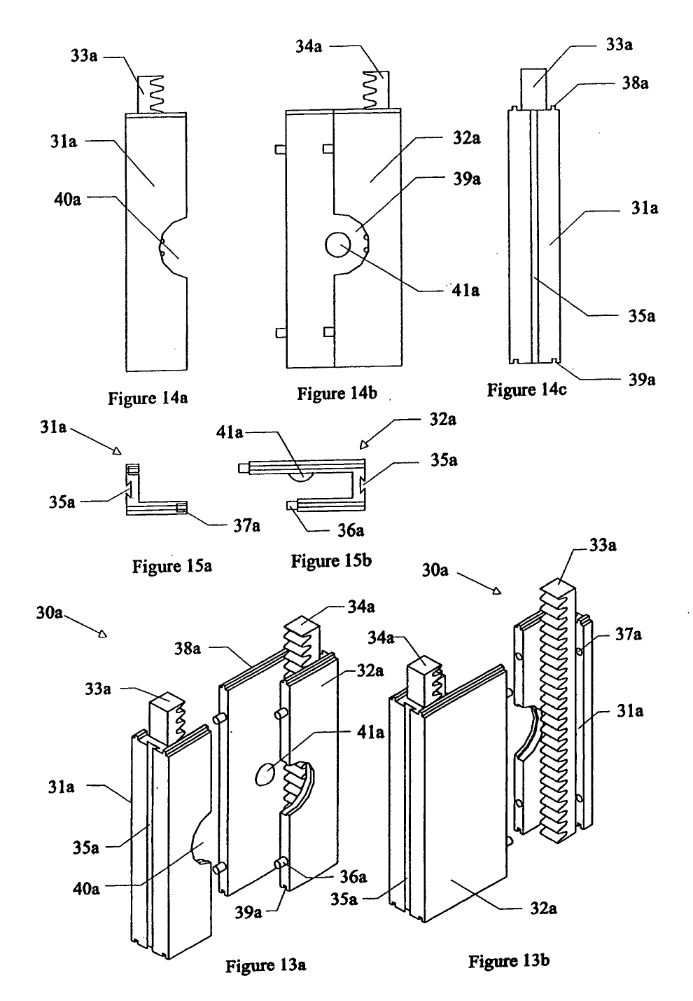

FIG. 4b is a front elevation of a second component of the modular unit shown in FIG. 13a;

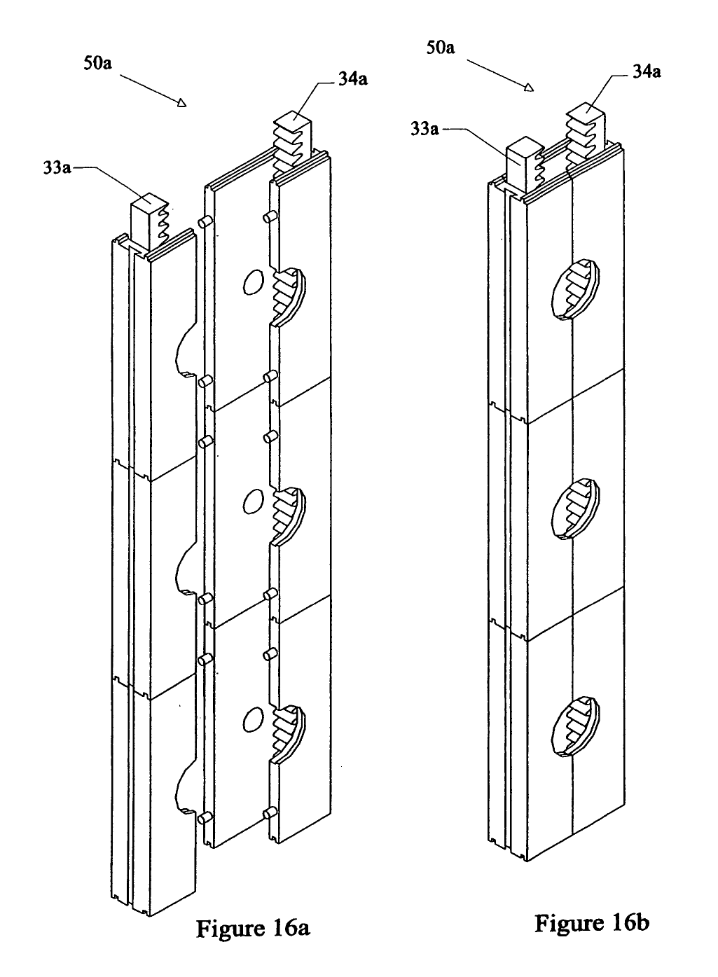

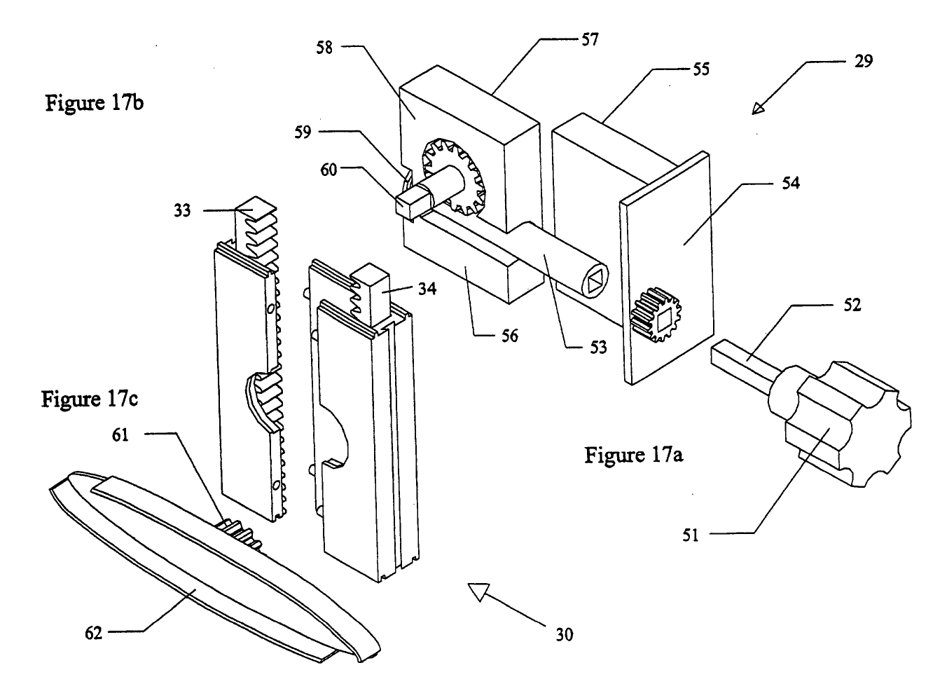

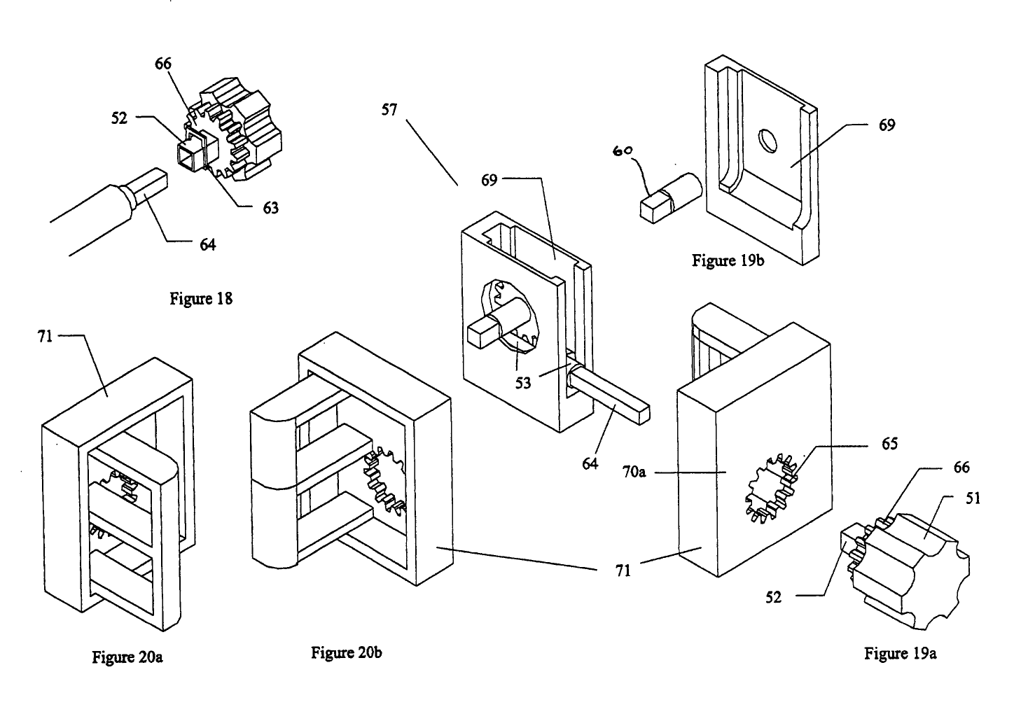

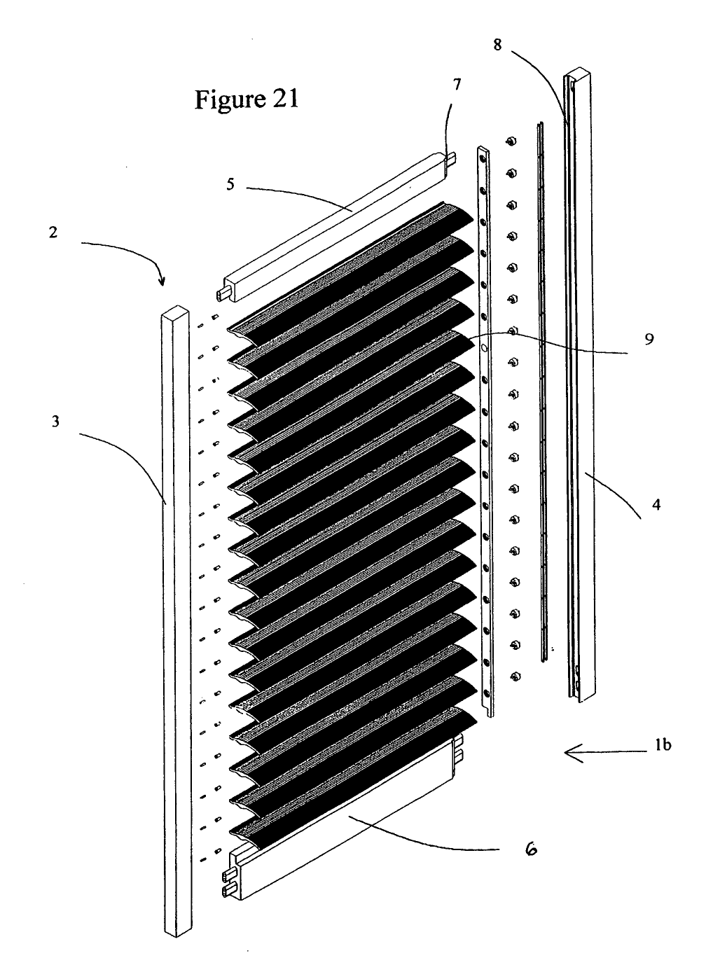

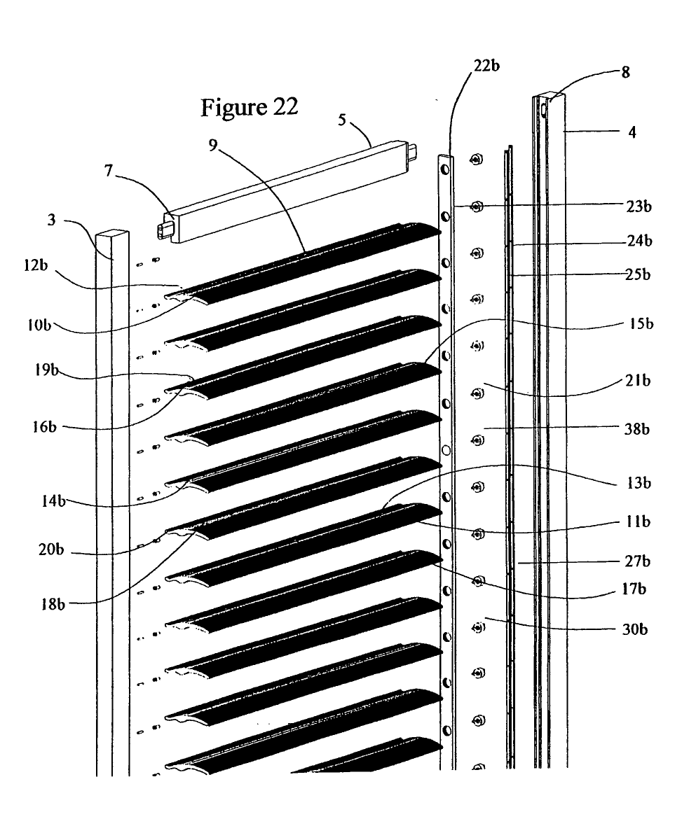

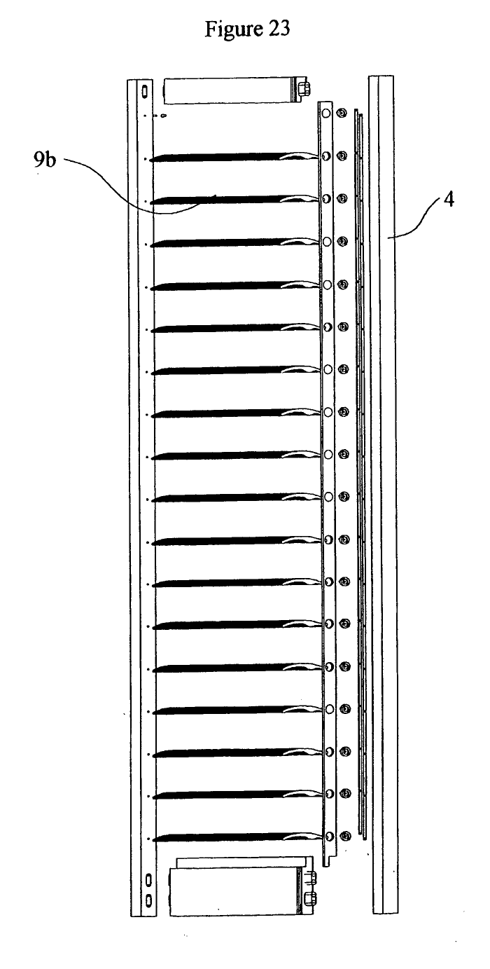

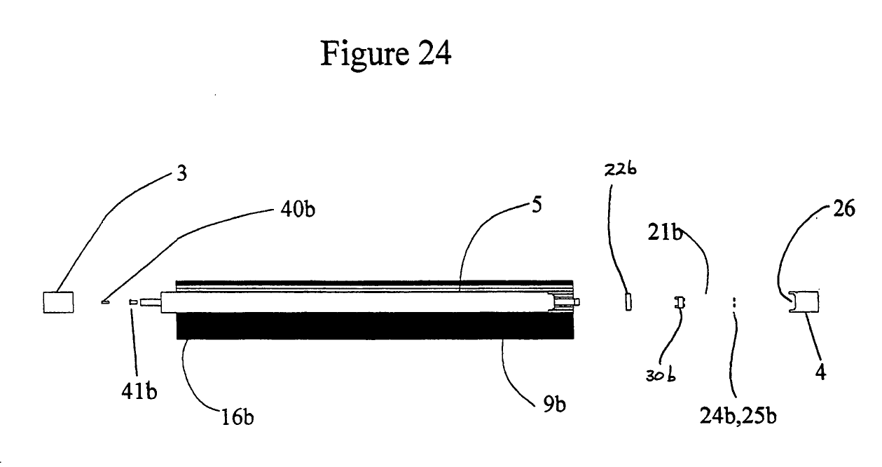

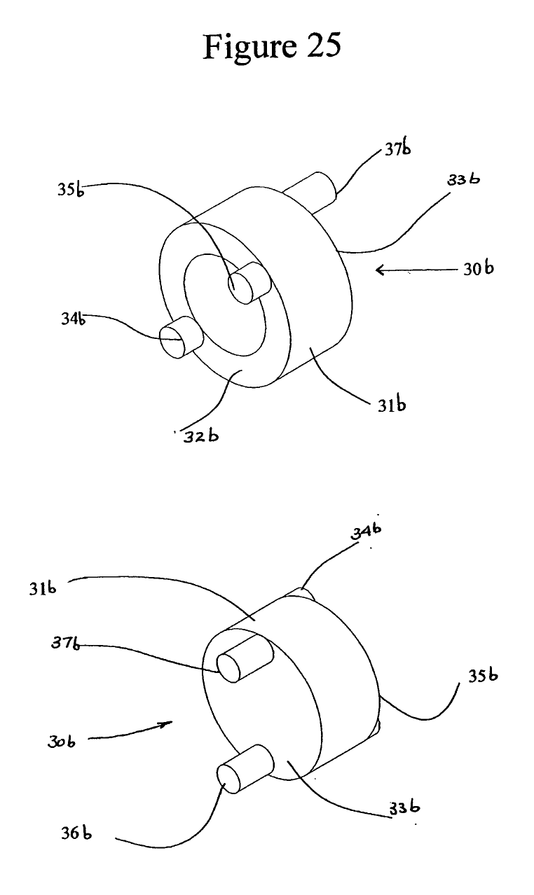

FIG. 14c is a side elevation of the modular unit shown in FIG. 13a;

FIG. 15a is a top plan view of the first component shown in FIG. 14a;

FIG. 15b is a top plan view of the second component shown in FIG. 14b;

FIG. 16a is a perspective view of a partially assembled elongate member according to the third embodiment;

FIG. 16b is a perspective view of the elongate member of 16a in assembled form;

FIG. 17a is an exploded view of a turning mechanism for use in the shutter assembly according to the third embodiment;

FIG. 17b is an exploded view of a two piece modular unit according to the third embodiment;

FIG. 17c is a partially cut away perspective view of an end cap for placement on the end of a shutter blade according to the third embodiment;

FIG. 18 is an exploded perspective schematic view of the internal workings of a handle according to the third embodiment;

FIG. 19a is an exploded perspective view of the turning mechanism according to the third embodiment;

FIG. 19b is a schematic perspective view of a spigot located in an aperture in the external wall of a gear housing according to the third embodiment;

FIG. 20a is a perspective view of a turning mechanism cover according to the third embodiment;

FIG. 20b is a perspective view of the cover of FIG. 20a rotated 90°;

FIG. 20c is a schematic representation of a motor housed in the cover according to the third embodiment.

Contoured Blade

FIG. 21 is an exploded perspective view of a fourth embodiment;

FIG. 22 is a closer view of the exploded arrangement of FIG. 21;

FIG. 23 is a perspective view of the arrangement shown in FIGS. 21 and 22;

FIG. 24 is a schematic exploded representation of the means for mounting a shutter blade according to the fourth embodiment; and

FIG. 25 shows perspective front and rear views of the crank key used according to the fourth embodiment.

### DETAILED DESCRIPTION OF THE DRAWINGS

Cassette for Shutter Assembly

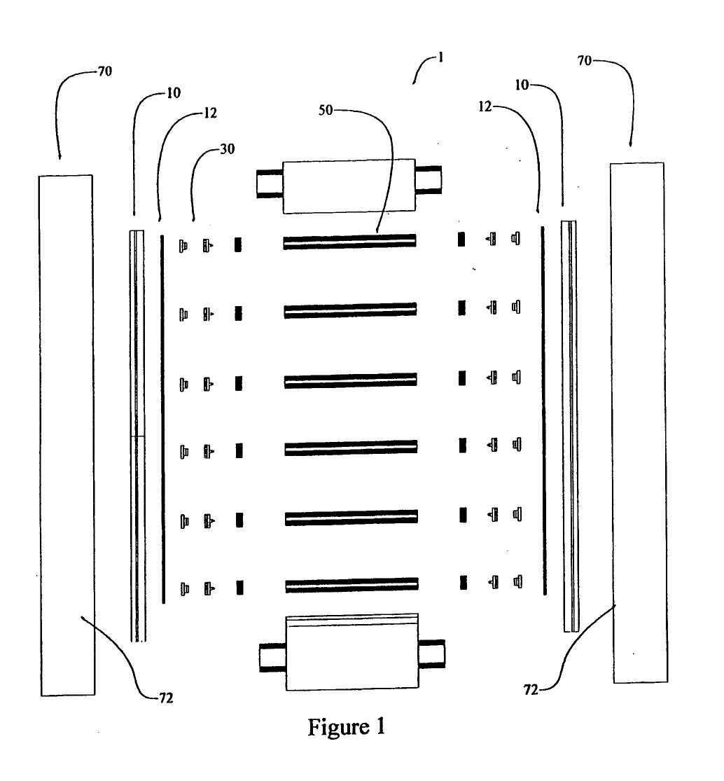

In FIG. 1 there is shown a shutter assembly 1 including a pair of opposed elongate parallel and spaced housings 10, a pair of racks 12, a plurality of bosses 30 and a plurality of shutter blades 50 shown in the closed position. FIG. 1 also shows schematically a pair of vertical stiles 70, each stile 70 including a rabbeted recess 72 adapted to receive one of the housings 10.

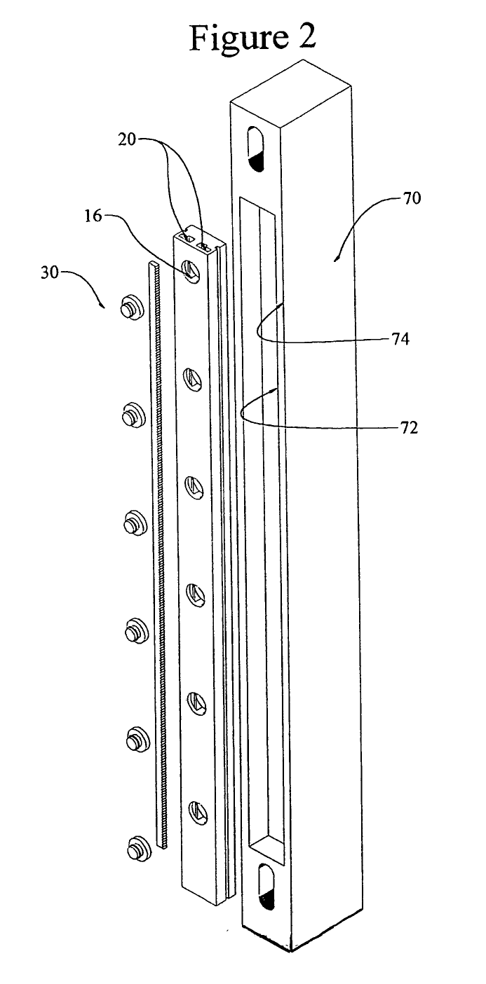

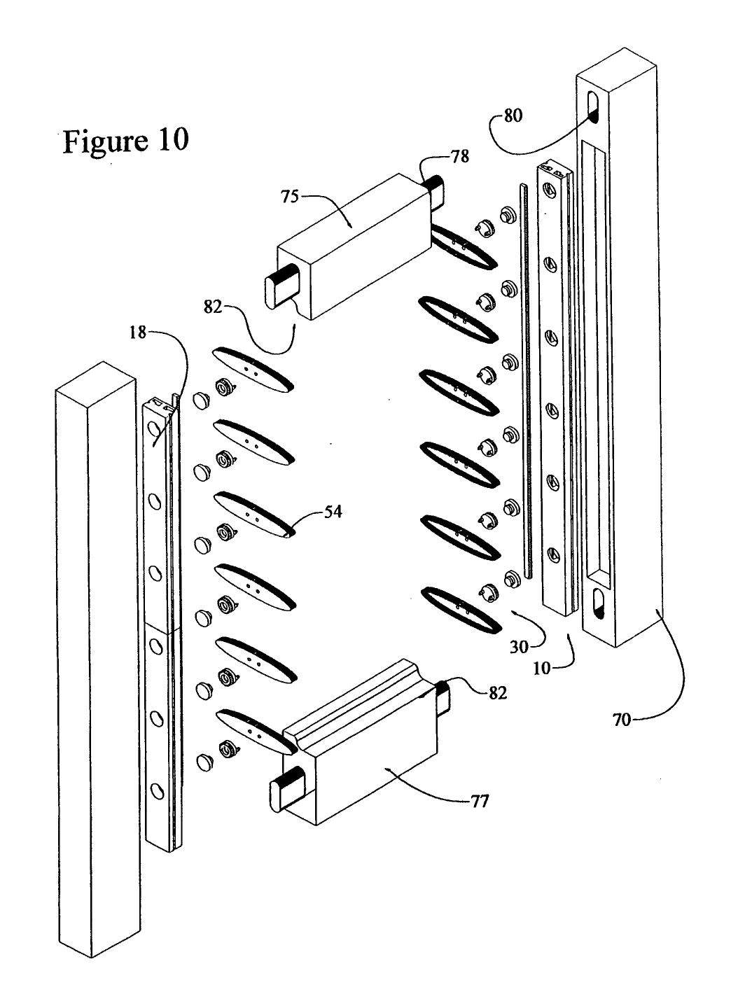

In FIG. 2 the recess 72 is more clearly shown to be a rectangular slot adapted to receive the housing 10 so that the housing 10 lies flush with the inner facing surface 74 of the stile 70. The housing 10 may define an internal cavity (not shown) which communicates with the outside environment at either end of the housing 10 and through a plurality of regularly spaced first apertures 16 and a plurality of second apertures 18 (see FIG. 10). The cavity may include a rack slot 20 and a larger boss chamber (not shown). The first apertures 16 act as supports for the bosses 30.

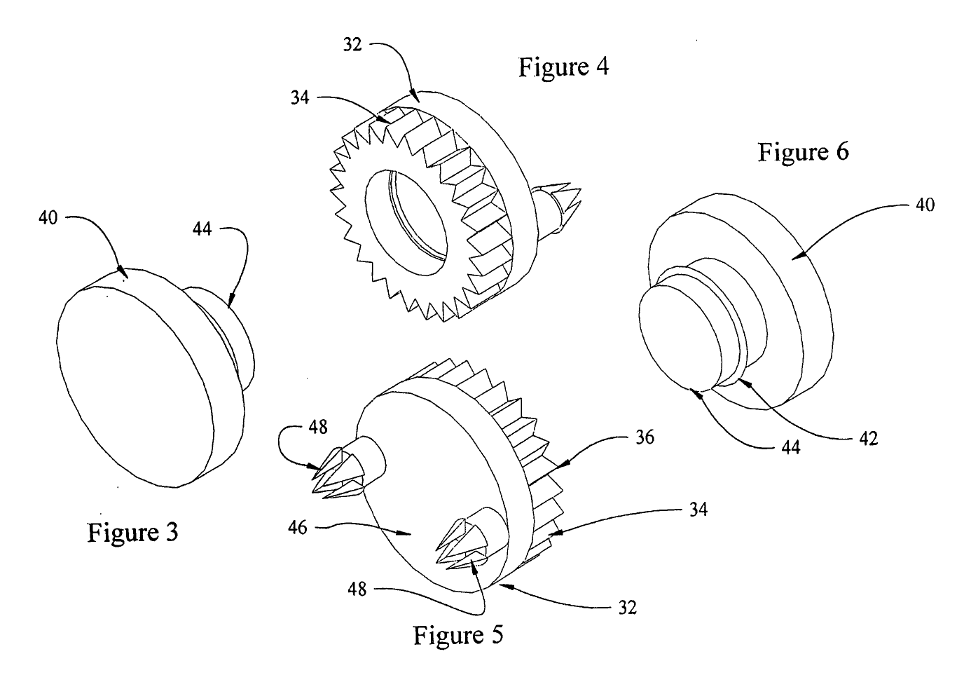

Turning to FIGS. 3, 4, 5 and 6, the boss 30 includes a compact cylindrical section acting as a bearing surface 32 adapted to rest in and through the first aperture 16, a gear section 34 having radially arranged teeth 36 which are adapted to engage the complementarily shaped and dimensioned teeth of the rack 12. The boss 30 further comprises a bush 40 and a snap lock locater head 44 having an annular bead 42 on the head 44 thereof to laterally compress to enable its insertion through the second aperture 18. The bush 40 acts as a short spindle and is aligned coaxially relative to the boss 30 as a whole. On the bearing inner face 46 of the bearing 32 are a pair of spaced, offset snap-lock locaters 48 adapted to engage corresponding apertures in an end cap of a shutter blade 50.

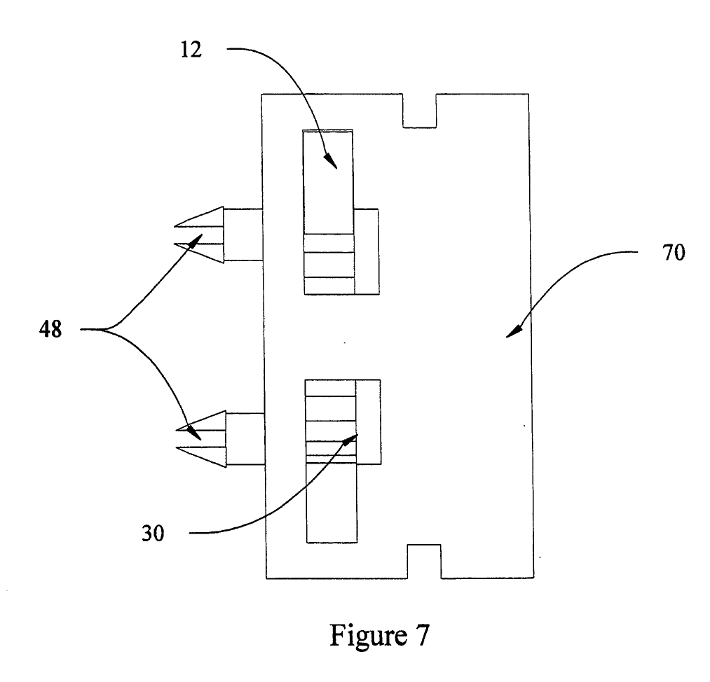

In FIG. 7 the boss 30 is shown mounted for rotation in a housing 70. It will be appreciated that the teeth 36 of the gears 34 positively engage the complementary teeth of the rack 12 whereby upon the vertical living and displacement of the rack 12 the boss 30 rotates clockwise or counter-clockwise as the case may be causing the blade locaters 48 to rotate through an archial path. The inner surface 46 of the bearing 32 is dimensioned to lie flush with the inner surface 74 of the stile 70.

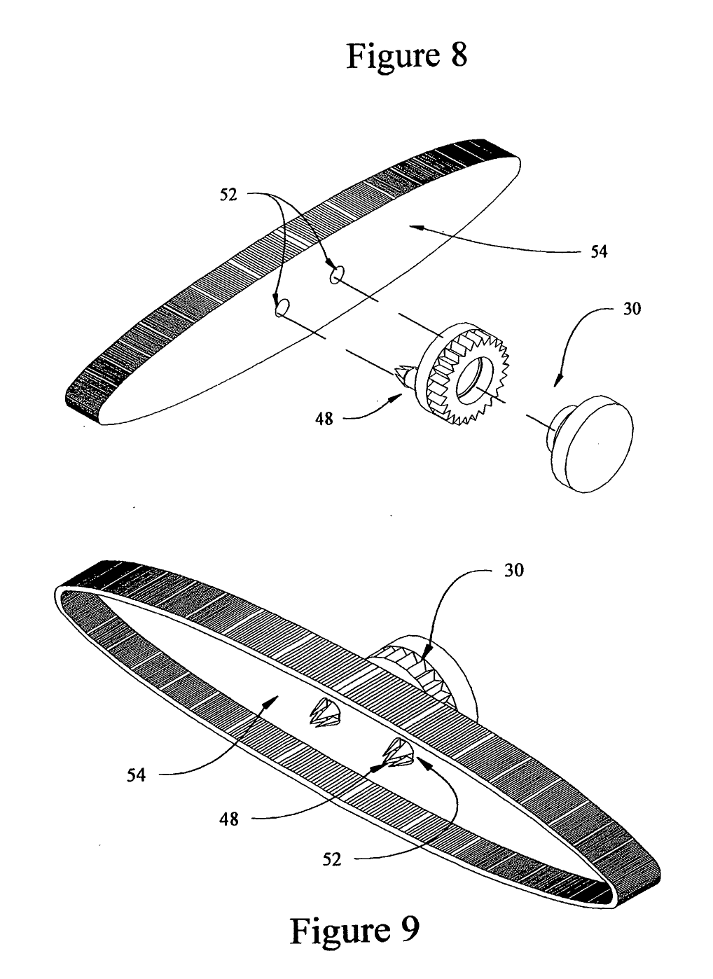

In FIGS. 8 and 9 the boss is shown to be aligned with a pair of third apertures 52 in the end cap 54 of a blade 50. The blade locaters 48 are spaced and adapted to be lockably inserted into the pair of apertures 52 whereby to engage the boss 30 with the end cap 54 as most clearly shown in FIG. 9.

In FIG. 10 the stiles 70 may be strengthened by the inclusion of a top rail 75 and a bottom rail 76. The top and bottom rails 75, 76 may include tenons 78 adapted to be fixably received in mortices 80 in a manner common in the art. The top and bottom rails 75, 76 may include bevelled or grooved edges 82 adapted to receive the top and bottom edges of the upper and lower most blades 50 to provide a secure and weatherproof seal when the shutter blades are in the closed position. In a particularly preferred embodiment, the boss 30 and end cap 54 are manufactured as a discrete, complete and/or integrated unit.

In use, the shutter assembly 1 in the form of a cassette may be installed in pre-assembled form simply by rabbeting the recess 72 to accommodate the housing 10 and installing the cassette with or without the top and bottom rails 75, 76. Accordingly, this presents a significant advantage over the prior art because the need for the top and bottom rails 75, 76 are dispensed with. The tolerances in the butting and engaging services of the various componentary in the cassette are sufficiently high to resist substantial flexing of the housings 10 outside the general plane of the cassette when the blades 50 are in the closed position.

Modular Unit for Shutter Assembly

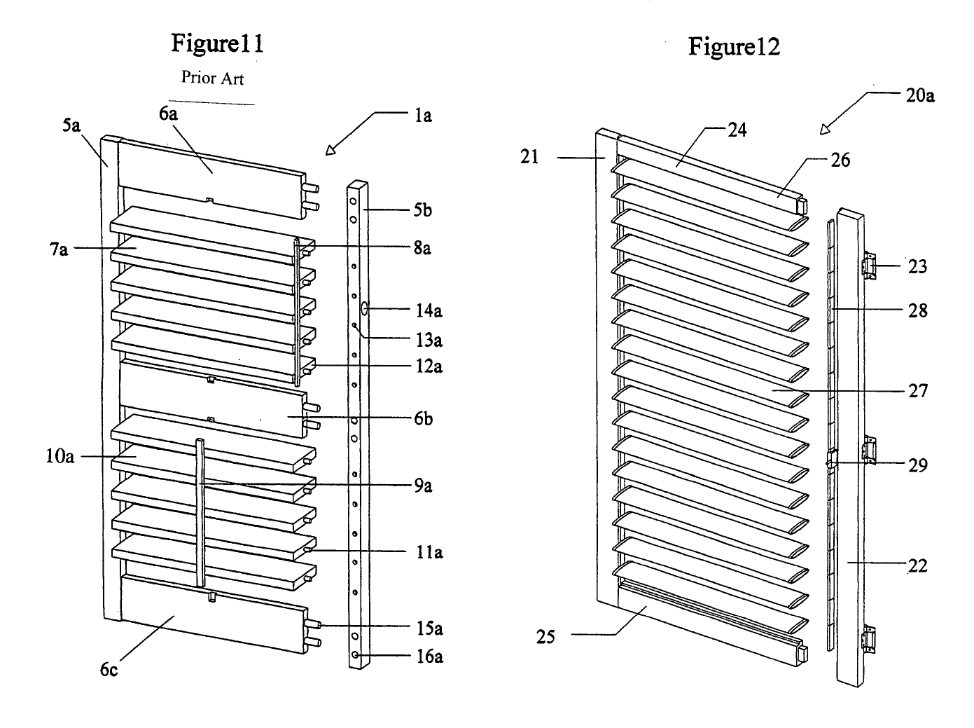

Referring firstly to the example of the prior art shown in FIG. 11, a frame is shown comprising a pair of small profile side rails 5a, 5b held together by interposed top-mid-and bottom-rails 6a, b, c. A plurality of shutter blades 7a are shown in the top section of the prior art shutter assembly 1a connected together for synchronised rotation by a side mounted control stick 8a which may be nailed or pinned into the end grain of the wooden shutter blades 7a. An alternative arrangement is shown in the bottom section of the prior art shutter assembly 1a wherein a vertical middle control stick 9a is used to synchronise the rotation of blades 10a and is attached by staples or pins to the blades 10a. In the prior art shutter assembly 1a the shutter blades 7a, 10a are pivotably mounted to the side rails 5a, 5b by small dowels or pins 11a located on the exposed end grain 12a of the blades 7a, 10a and located in corresponding apertures 13a in the side rails 5a, 5b. A wood screw 14a is required to keep tension on the blades 7a, 10a. The top-mid-and bottom-rails 6a, 6b, 6c are secured to the side rails 5a, 5b by large dowels 15a adapted to be received in corresponding holes 16a.

In contrast, a shutter assembly 20a made in accordance with a third embodiment of the invention is shown in FIG. 12. The shutter assembly includes large profile side rails 21, 22. One of the side rails 22 may optionally be hinged 23 to a wall structure. The shutter assembly 20a does not include a mid rail but only top rail 24 and bottom rail 25 fixedly engaged to the side rails 21, 22 by tenon joints 26.

The shutter assembly 20a includes a plurality of shutter blades 27 extending between the side rails 21, 22. The mounting of the blades 27 to the side rail 21 may include a simple free pivot arrangement. However, in the preferred embodiment the mounting of the blades 27 to the side rail 22 includes a translating mechanism 28. The translating mechanism 28 is controlled by a motor driven turning mechanism 29. It can be seen that, not only is the shutter assembly 20a frame less obtrusive relative to the prior art, but it is more visually appealing because the translating mechanism 28 is unobtrusive.

Turning now to FIGS. 13a and 13b, there is shown a two piece modular unit 30a including a first component 31a and a second component 32a. A pair of opposed translating members in the form of toothed racks 33a, 34a are included to clearly show their position in the modular unit 30a once assembled, but it will be appreciated that prior to assembly the first and second components 31a, 32a do not include the racks 33a, 34a. Each side wall of the first and second components 31a, 32a includes a truncated triangular section groove 35a suitable for mounting the assembled elongate member to a correspondingly configured bead (not shown). The first and second components are engageable by interference fit by two pairs of pins 36a located on the second component 32a. The pins 36a are adapted to be inserted into apertures 37a located in the first component 31a to tightly engage the first and second components 31a, 32a together. The assembled modular units 30a may be stacked in series one above the other by vertical engagement means in the form of elongate tongue 38a and groove 39a features whereby to form an elongate member. The first and second components 31a, 32a combine to define a large aperture 40a from the combination of a pair of aligned semi-circular cutouts. Coaxial with the large aperture 40a is a rounded protrusion 41a on an inner wall of the second component 32a. The protrusion 41a is adapted to locate within a corresponding recess of a compact boss (not shown) to ensure that the compact boss rotates about a constant axis. It will be appreciated that, equally serviceable would be n arrangement in which the protrusion 41a was located on the boss and the corresponding recess on the inner wall of the second component 32a.

FIGS. 14a, 14b, 14c, 15a and 15b more clearly show the various features of the modular unit. FIG. 16a shows a set of three modular units 30a stacked one on top of the other to form two parts of an elongate member 50a. The elongate member 50a optionally includes the racks 33a, 34a prior to assembly. The elongate members are built in series and able to be front loaded. They are therefore very easy to assemble (and retrofit in the future if a blade 27 requires removal). The component 32a (see FIG. 13a) is mounted to each opposing stile edge of the frame including side rails 21,22 by male to female fitting (tongue and groove features) 38a,39a. This ensures accurate alignment along the line of groove 35a and the frame is tightly secured via features 38a,39a. This also guarantees the correct pitch of protrusion 41a being the pivotal pitch point for each and various sized blades 27 (and end caps 62 shown in FIG. 17c). The unique method of assembly following the securing of component 32a is to insert rack 34a, followed by blade and end cap 27,62 which snaps into the semi-circular groove 39a of component 32a. This is followed by laying rack 33a into the assembly wherein the gears of the rack 33a mesh with a pinion 61. Finally component 31a is snapped via pins 36a (see FIG. 13a) into apertures 37a (see FIG. 13b) ensuring the encapsulation of the rack and pinion assembly.

Referring to FIG. 17a, the turning mechanism 29 is shown in detail. The turning mechanism 29 includes a handle 51 having a square sectioned spindle 52 adapted to rotatably co-operate with a worm 53 coaxially aligned with the spindle 52. When the handle 51 is rotated the worm 53 also rotates. Optionally, the relationship between the spindle 52 and the worm 53 may be geared and in such case, the spindle 52 and the worm 53 may not be coaxial. The spindle 52 is received through an aperture in a cover wall 54 of a housing 55. The housing 55 optionally includes a turning motor (not shown) in which case the handle 51 is in the form of a bi-directional motor actuator. The worm 53 is rotatably mounted in a cylindrical bore or semi-cylindrical channel 56 of a gear housing 57. The gear housing 57 includes a toothed wheel gear 58 set for rotation in a tight fitting cylindrical bore in the gear housing 57 whereby the wheel gear 58 rotates about an axis normal to that of the worm 53. Extending outwardly from the wheel gear 58 is a gear spindle 59 on which may be mounted a compact boss (not shown) adapted to co-act with the racks 33a, 34a shown in FIG. 17b. The square sectioned end 60 of the gear spindle 59 is adapted to engage a correspondingly square sectioned bore (not shown) set in an end cap 62. The end cap 62 shown in FIG. 17c is adapted to fit over the end of the shutter blade 27 shown in FIG. 12 as an end sleeve in a tight interference fit.

Referring to FIG. 18, the internal structure of the handle 51 is shown in more detail. The handle 51 includes a spindle 52 over which is placed a circlip 63. The spindle 52 is a hollow square sectioned shaft adapted to receive a corresponding square section male portion 64 of the worm 53. Referring to FIG. 19a, the handle 51 is mounted for rotation by means of a boss 66 engagedly mounted in a correspondingly toothed aperture 65 extending through the housing 55. The housing 55 may include a motor (not shown) such as a small electric motor actuable by the handle 51 and configured to rotate the spindle 52 which in turn rotates the worm 53. As shown in FIG. 19b the end of the gear spindle 59 opposed to the square sectioned end 60 is cylindrical in cross-section and is adapted to freely rotate in a circular aperture of the exterior wall 69 of the gear housing 57. FIGS. 20a and 20b show the turning mechanism housing 55 from different perspectives. The housing 55 includes a front facia 70a from which extends four shallow walls 71 defining a cavity within which a motor may be housed.

Contoured Blade

With reference to FIG. 21, there is shown a shutter arrangement 1b having a frame 2 comprising a vertical post 3 on one side and a stile 4 on the other side, the vertical post 3 and the stile 4 spaced in parallel arrangement in their installed state by horizontal frame members or rails, a top rail 5 and a bottom rail 6. Upon installation, the tenons 7 are inserted in corresponding mortises 8 in the vertical post 3 and the stile 4. Pivotally mounted in the frame 2 is a plurality of shutter blades 9 shown in their open, horizontal position.

As shown most clearly in FIG. 22, each shutter blade 9 comprises an integrally formed elongate body comprising a main portion 10b having a main longitudinal edge 11b, a minor portion 12b having a minor longitudinal edge 13b, each of the main and minor portions 10b, 12b joined at a thickened portion 14b. Each blade 9 includes a stile end 15b and a post end 16b.

It can be seen that the top external surface 17b of the main portion is concave in profile and the underside surface 18b of the main portion 10b is correspondingly marginally concave in profile whereby the underside surface 18b closely follows the contour of the top external surface 17b, the main portion 10b tapering marginally towards the main longitudinal edge 11b.

The top external surface 19b of the minor portion 12b has a concave profile defining a depression between the minor longitudinal edge 13b and the thickened portion 14b. The underside surface 20b of the minor portion follows the contour of the minor top external surface 19b between the thickened portion 14b and the minor longitudinal edge 13b.

As the person skilled in the art can appreciate, when the blade 9 is pivoted from the horizontal position shown in FIG. 22 to a vertical closed position (not shown) by causing the main longitudinal edge 11b to travel in an arc downwards and the minor longitudinal edge 13b to travel in a smaller arc upwards, the blades 9 are spaced so that the main longitudinal edge 11b rests on the minor top external surface 19b whereby to provide a substantially weatherproof seal.

The blades 9 of the shutter arrangement 1b provide improved heat and light transference through the opening defined by the frame 2 due to the aerofoil profile of the blades 9. It can be seen that the blades, at any position inclined to the vertical, will permit the transfer of external light by direct reflection into a building. This permits an operator to adjust the inclination of blades 9 to a preferred setting for aesthetic or privacy reasons, whereby the top external surface will still permit direct reflection of external light through the shutter opening into the interior of the building. The aerofoil profile of the blades 9 further enhance the flow of air through the shutter opening by the creation in air pressure differentials in the regions immediately surrounding the blades 9 to improve air circulation.

The complementary shapes of the upturned minor longitudinal edge 13b and the slightly downwardly curved main longitudinal edge 11b provide an improved weather seal when the blades are in the closed position. The improved weather seal provides improved heat and light insulation.

The pivoting mechanism 21b comprises an elongate infill bar 22b, a plurality of crank keys 30b and a pair of elongate parallel positioned rods 24b, 25b all adapted to be housed within the stile 4. As best seen in FIG. 24, the stile 4 is rabbeted to define a recess 26b in which the pivoting mechanism 21b may be fully housed and aesthetically hidden from view after installation.

As most clearly seen in FIG. 25, each compact boss or crank key 30b comprises a wheel 31b having an inward face 32b and an outer face 33b. The inward face 32b has a pair of opposed pegs 34b, 35b and the outer face 33b has a second pair of opposed pegs 36b, 37b. It can be seen that the inner pegs 34b, 35b are offset relative to the outer pegs 36b, 37b whereby to restrict the maximum pivoting arc of the blades 9 to about 130°. The outer pegs 36b, 37b for each crank key 30b are located in correspondingly located apertures 27b. It will be appreciated that when the pair of rods 24b, 25b are subjected to opposed reciprocal motion, for example first rod 24b moves downwardly and second rod 25b moves upwardly, the crank key 30b will pivot about its central axis 38b. Accordingly, when the inner pegs 34b, 35b are located in corresponding apertures (not shown) in the thickened portion 14b of the stile end 15b of each of the blades 9, the rotation of the crank key 30b described above will cause the blades 9 to pivot towards the closed position.

As best seen in the top plan view shown in FIG. 24 the blades 9b may be mounted to the frame 2 by means of a fastener rotationally mounting the post end 16b to the vertical post 3 by means of a lug 40b inserted in an aperture defined by insert 41b located in the thickened portion 14b. At the stile end 15b, the blade 9b is mounted by means of a screw type fastener extending from the stile 4 extending between the rods 24b, 25b through the crank key 30b and the infill 22b and is located in the stile end 15b of the blade 9b.

Throughout the specification the word “comprise” and its derivatives is intended to have an inclusive rather than an exclusive meaning unless the context requires otherwise.

It will be appreciated by those skilled in the art that many modifications and variations may be made to the embodiments described herein without departing from the spirit or scope of the invention.

1. A shutter assembly having a plurality of modular units, each modular unit adapted to mount a shutter blade and including:
an elongate member unit stackable and engageable to like elongate member units to form an assembled elongate member; and
a support for a compact boss adapted to be engaged to the shutter blade, whereby rotation of the compact boss causes rotation of the shutter blade
wherein the elongate member is adapted to facilitate the reciprocal travel of a translating member along or within the assembled elongate member and the support is adapted to support the compact boss for co-action with the translating member to translate the reciprocal motion of the translating member into rotational motion in the compact boss whereby to pivot the shutter blade.

2. A shutter assembly according to claim 1, wherein the elongate member unit includes a pair of separately formed and joinable half components.

3. A shutter assembly according to claim 1, wherein the assembled elongate member units form a housing for the compact boss and the translating member.

4. A shutter assembly according to claim 1, wherein the translating member is controlled by a motorized turning means having sensors responsive to environmental conditions.

5. A shutter assembly according to claim 1, wherein the elongate member unit may be formed from one or more components.

6. A shutter assembly according to claim 1, wherein the elongate member unit may include a unitary integrally molded component.

7. A shutter assembly according to claim 1,
wherein the elongate member unit may include a cast component.

8. A shutter assembly according to claim 1, wherein the engagement of the modular unit to adjacent like member units may include a variety of modular unit engagement means.

9. A shutter assembly according to claim 8, wherein the modular unit engagement means may include male members adapted to engagedly co-operate with female members on an adjacent member unit.

10. A shutter assembly according to claim 9, wherein male members include headed pins.

11. The shutter assembly of claim 8, wherein the modular unit engagement means include snap lock locaters.

12. The shutter assembly of claim 8, wherein the modular unit engagement means include any one chosen from the group of apertures, grooves, tracks, slots or the like.

13. A shutter assembly according to claim 1, wherein the compact boss includes:
a) a short axial member whereby the boss is adapted to rotate about the axis of the axial member;
b) a complementary surface adapted to engage the translating member capable of translating the linear motion of the translating member into rotational movement of the boss;
c) a bearing surface adapted to rest in or on a support in the shutter assembly; and
d) blade engagement means to impart rotational motion to the blade corresponding to the rotational motion of the boss.

14. A shutter assembly according to claim 13, wherein the blade engagement means engages the boss with the blade at two or more locations off-centre relative to the axis of rotation of the axial pin.

15. A shutter assembly according to claim 13, wherein the blade engagement means includes at least one protrusion extending from either the boss or the shutter blade, such that the protrusion of the boss or the shutter blade is keyed to co-act with a correspondingly configured recess in the shutter blade or the boss, respectively.

16. A shutter assembly according to claim 13, wherein the engagement means includes a pair of protrusions lockably engageable to corresponding recesses in an end of the shutter blade.

17. A shutter assembly according to claim 13, wherein the complementary surface includes a combination of ridges and recesses adapted to cooperate with complementary features on the translating member.

18. A shutter assembly according to claim 13, wherein the complementary surface is in the form of geared teeth.

19. A shutter assembly according to claim 1, with a plurality of the bosses defined in claim 13, said shutter assembly including:
a pair of opposed, parallel, spaced elongate members, at least one said elongate member having a plurality of the supports, each support adapted to support one of the plurality of bosses;
the translating member adapted to travel reciprocally along or within at least one of said elongate members; and
a plurality of the shutter blades, each said blade engaged with one of said bosses.

20. A shutter assembly according to claim 19, wherein the at least one elongate member is in the form of a housing adapted to house a plurality of the bosses.

21. A shutter assembly according to claim 19, wherein each boss includes seal means to prevent the ingress of dirt and grime into the housing.

22. A shutter assembly according to claim 19, wherein the seal means includes a bush coaxial to, and from which extends, the axial pin.

23. (Cancelled)
